(19) United States
(12) Patent Application Publication
(10) Pub. No.: US 2023/0312629 A1
(43) Pub. Date: Oct. 5, 2023

(54) PROCESS FOR SEPARATING LIGNIN FROM BLACK LIQUOR

(71) Applicant: Mondi AG, Vienna (AT)

(72) Inventors: Thomas PICHLER, Gabersdorf (AT); Mattaus SIEBENHOFER, Graz (AT); Marlene KIENBERGER, Graz (AT)

(73) Assignee: Mondi AG, Vienna (AT)

(21) Appl. No.: 18/043,097

(22) PCT Filed: Aug. 26, 2021
(86) PCT No.: PCT/AT2021/060298

§ 371 Date: Feb. 27, 2023

(30) Foreign Application Priority Data
Aug. 27, 2020 (AT) A 50725/2020

(51) Int. Cl. C07G 1/00; D21C 11/00

(52) U.S. Cl. CPC C07G 1/00; D21C 11/0007

(57) ABSTRACT

A process for separating lignin and volatile reaction products from a black liquor derived from pulp production, lignin is demethylated in a heat treatment reactor and CH₃⁺ ions separated out are reacted with reduced sulphur-containing components from cooking chemicals in the black liquor to form DMS a rise in pressure in the heat treatment reactor is controlled and DMS is withdrawn when a pressure of ≥15 bar to ≤40 bar, is reached in the heat treatment reactor the black liquor which is depleted in DMS is transferred to a first precipitation stage and CO₂ and/or sulphur-containing reaction products are added to precipitate out a slurry containing demethylated lignin which is transferred into a second precipitation stage with at least one sulphur-containing acidifying agent, and the precipitated unrefined slurry containing demethylated lignin is discharged from the second precipitation stage; and supplied to a demethylated lignin separation step.

### BACKGROUND OF THE INVENTION

The present invention relates to a process for separating lignin and volatile reaction products, such as DMS, from a black liquor deriving from pulp production, in which lignin contained in the black liquor is demethylated in a heat treatment reactor and CH₃⁺ ions separated out of the lignin are reacted with reduced sulphur-containing components from cooking chemicals contained in the black liquor to form DMS and DMS is withdrawn from the heat treatment reactor.

Processes for separating lignin from black liquor by precipitation are known per se from a large number of documents. The best known of these processes which have been described are the LignoBoost process and the LignoForce process. In these processes, lignin is precipitated out from black liquor and a modification of the lignin prior to precipitation is not carried out in these processes. In addition, in the literature such as CA 2 839 864 A1 for example, two-stage precipitation processes have been described in which the actual precipitation of lignin occurs only in the second stage. In the first stage, untreated original black liquor is conditioned for the subsequent precipitation.

Furthermore, it is known from the literature that in the case of a heat treatment of black liquor, in particular at temperatures of up to 170° C., the viscosity of the black liquor falls and this fall in the viscosity improves the filtration of the precipitated lignin in particular. In this regard, the reduction in the viscosity and also the improved filterability is carried out by means of a reduction in the remaining hemicellulose content and furthermore by means of a reduction in the molar mass of the lignin. A reduction in the molar mass of lignin during the heat treatment or during the decomposition of larger macromolecules is a desirable step because on the one hand, the decomposition of macromolecules produces lignin polymers which more closely remember a desired phenolic form than the starting macromolecules, and on the other hand, during the heat treatment, lignin demethylation takes place to a certain extent, and the CH₃⁺ unit of the methoxy groups of lignin reacts with reduced sulphur-containing components in the cooking chemicals such as HS⁻ ions, for example, and forms dimethyl sulphide as a major product. The demethylated form of lignin which is formed is particularly suitable for use in phenol formaldehyde resins because a demethylated form of lignin of this type has an enhanced reactivity and therefore a reaction of lignin with formaldehyde is facilitated, so that a substitution of phenol in phenol formaldehyde resins is possible.

Finally, WO 2018/115592 A1 describes a process for the demethylation and precipitation of lignin in which demethylation and precipitation take place simultaneously because of the formation of acid during the heat treatment. In that process, a Ph adjustment step is carried out prior to the heat treatment in order to be able to precipitate lignin out of the solution as rapidly and completely as possible in this manner.

WO 2021/154143 A1 describes a treatment of a mixed stream which is obtained from a decomposition or transformation of mechanical pulp, the process comprising one or more treatment units which are disposed in order to withdraw at least one first component from the other components in the material stream and form a first product stream containing this first component, whereupon the purity of a second component contained in the mass stream is concentrated.

Despite this multitude of different known processes with which lignin can be precipitated out or removed from black liquor and the widely differing treatment methods for improving the properties of this lignin, the lignin residues remaining in the black liquor are still very high in all of these processes and moreover, in most known processes, lignin precipitation occurs during the black liquor treatment, which does not facilitate the procedure because of the necessary subsequent separation and difficult or expensive purification of the desired product.

### SUMMARY OF THE INVENTION

The present invention is now aimed at the provision of a process with which, on the one hand, the separation of dimethyl sulphide from black liquor can be optimized, and at the same time, as high a fraction of the lignin can be precipitated out of the black liquor as possible, and therefore a lignin can be obtained from the process which has as low a molar mass as possible and as low a methoxy group content as possible, and thus can be directly and successfully used in a multitude of processes.

In order to achieve this objective, the process in accordance with the invention is essentially characterized in that a rise in pressure in the heat treatment reactor is controlled and DMS as well as other possible volatile reaction products are withdrawn therefrom, repeatedly where necessary, when a pressure of ≥15 bar to ≤40 bar, preferably ≤30 bar is reached in the heat treatment reactor, in that the black liquor which is depleted in DMS as well as other possible volatile reaction products is transferred into a first precipitation stage and CO₂ and/or offgases, for example from a recovery reactor or a lime kiln, are added in order to precipitate out a slurry containing demethylated lignin, in that the slurry containing demethylated lignin is transferred into a second precipitation stage with at least one sulphur-containing acidifying agent and in that the precipitated unrefined slurry containing demethylated lignin is discharged from the second precipitation stage and supplied to a demethylated lignin separation step and also at least a portion of the withdrawn other volatile reaction products, in particular sulphur-containing reaction products, is recycled to the process. Because a rise in pressure in the heat treatment reactor is controlled and because other possible volatile reaction products are withdrawn at least after a pressure of ≥15 bar to ≤40 bar, preferably ≤30 bar, is reached in a heat treatment reactor, this means that the reaction equilibrium for the demethylation of lignin in the heat treatment reactor is displaced so far that the reaction continues for as long as as-yet non-demethylated lignin and sulphur which derives from the pulp production is available for a reaction to form DMS. In a process in accordance with the prior art, in which a withdrawal of DMS at least after a specific pressure rise does not occur, and therefore an uncontrolled pressure increase in the reactor is not avoided, with a spontaneous withdrawal of DMS, lignin units bond together into larger units and the molecular weight of lignin rises in an unwanted manner. When, as in the present process, the DMS which is formed is withdrawn at least repeatedly after reaching a certain pressure increase and an uncontrolled pressure increase is avoided, then the reaction equilibrium is successfully displaced and the reaction can be run as long as lignin which has methoxy groups which are capable of reacting is present. Furthermore, with this procedure, not only can lignin be successfully demethylated, but above all, the molecular weight of lignin can be kept low or can even be reduced compared with that of the starting material. Because the black liquor which is depleted in DMS as well as other possible volatile reaction products is subsequently transferred into a first precipitation stage and CO₂ and/or sulphur-containing reaction products is added in order to precipitate out a slurry containing demethylated lignin, a slurry can be successfully obtained which surprisingly contains a lignin which has a significantly lower molar mass compared with untreated lignin in the case of conventional precipitation.

In the context of the present invention, reaction products are withdrawn from the heat treatment reactor when a pressure of between approximately 15 bar, such as ≥15 bar, and approximately 40 bar, such as ≤30 bar, is reached. In this regard, these pressures are selected in a manner such that they approximately correspond to the vapour pressure of water at the temperature prevailing in the heat treatment reactor. The pressure at which volatile or gaseous reaction products are withdrawn from the heat treatment reactor is therefore governed by the temperature selected in this reactor and is usually between ≥15 bar and ≤40 bar.

Furthermore, because at least a portion of the DMS as well as other possible volatile reaction products which are optionally withdrawn is recycled to another location in the process during the procedure, on the one hand, the reaction equilibrium is displaced towards demethylated lignin so that the yield of this product can be maximized, and on the other hand, by means of this procedure, not only can a particularly high yield of demethylated lignin be obtained, but in addition, surprisingly, unwanted structural changes in the lignin during this procedure are prevented. This is particularly the case because, due to the prevention of large pressure changes in the heat treatment reactor, a condensation of lignin which is additionally observed for the usual temperatures present during the heat treatment is prevented.

Furthermore, because at least a portion of the other volatile reaction products, in particular sulphur-containing reaction products, which have been withdrawn from the precipitation stages is recycled to the process, on the one hand, for the precipitation of lignin, a mild acidification is carried out which is comparable to that with CO₂, and on the other hand, surprisingly, an accumulation of sulphur in the process is avoided because of the withdrawal of DMS and/or sulphur-containing gases. Furthermore, in a procedure of this type, a lignin with a lower molecular mass compared with conventional processes is obtained.

Furthermore, the procedure can be selected in a manner such that black liquor with a basic Ph value of between Ph 13.8 and Ph 12.8 is used, and such that the Ph value is reduced in each precipitation stage compared with the previous step in the process. Because the Ph value reduces in each precipitation stage compared with the previous stage of the process, this leads to a mild acidification. A reduction in the Ph value in the range from approximately 1.2 to 2.0 compared with the previous step of the process appears to be particularly advantageous. Furthermore, it has been shown that the more the Ph value is reduced, the more lignin can be precipitated out and in particular, the more lignin with a low molecular weight can be precipitated out. A procedure of this type therefore significantly improves the overall yield of low molecular weight demethylated lignin compared with conventional processes.

Only a portion of the lignin can be precipitated out with conventional processes for the precipitation of lignin from black liquor with CO₂. In the prior art processes, the known use of sulphur-containing mineral acids for lignin precipitation in particular is not possible because this leads to an excessive accumulation of sulphur ions in the recycling process. It is only the withdrawal of volatile reaction products, in particular of sulphur-containing reaction products such as DMS, that makes it possible to use sulphur-containing mineral acids in a second precipitation stage for the precipitation of lignin out of black liquor. This withdrawal of the sulphur-containing reaction products, for example DMS, now surprisingly favours the formation of lignin with low molecular weights. If now the Ph value in the second precipitation stage compared with that in the first precipitation stage is reduced further, the precipitation of even this surprisingly formed lignin with a low molecular weight is favoured, because this remains in solution at higher Ph values and cannot be precipitated out.

In accordance with a further embodiment of the invention, the process is carried out in a manner such that the volatile reaction products from the heat treatment, in particular DMS, are continuously withdrawn from the heat treatment step. By means of a continuous withdrawal of DMS in particular from the heat treatment, on the one hand, an increase in pressure, as described, can be prevented, and on the other hand, the displacement of the reaction equilibrium towards demethylated lignin which has been described is carried out continuously without excessive pressure and temperature loads in the heat treatment vessel.

In a further embodiment of the invention, because the process is carried out in a manner such that the offgases which are withdrawn from the heat treatment reactor as well as from the first precipitation stage, in particular sulphur-containing offgases such as DMS and H₂S, are supplied to the second precipitation stage as an acidifying agent following an oxidation, then on the one hand a higher yield of low molecular weight lignin is obtained, and on the other hand, it could surprisingly be shown that when the dimethyl sulphide is continuously or regularly withdrawn from the process, surprisingly, even though this is not directly linked to the withdrawal of DMS, a further reduction in the Ph value can be obtained and by means of this, the lignin precipitation yield can be significantly increased without having a negative influence on the sulphur balance, because no additional sulphur is added to the process, but only the sulphur which is circulating. The sulphur-containing offgases such as DMS or H₂S which are formed either during the heat treatment or during the precipitation are transformed by means of an oxidation step into SO₂ or H₂SO₄ which can be supplied to the second precipitation stage as an acidifying agent. A procedure of this type is therefore possible because on the one hand, it is only the reduction of sulphur in the black liquor which originates from the formation of DMS and from the discharge of DMS which is compensated for, and on the other hand, with a procedure of this type, a further reduction in the Ph value is obtained below the equilibrium Ph for CO₂ in the black liquor. By means of a procedure of this type, therefore, the lignin precipitation yield is significantly increased without simultaneously having a negative effect on the sulphur balance. Clearly, if sufficient SO₂ or H₂SO₄ cannot be formed from the offgases, these acids could also be supplied separately.

In similar manner and as described above, in a further embodiment of the process in accordance with the invention, offgas containing CO₂ and possibly H₂S withdrawn from the second precipitation stage is supplied to the first precipitation stage as an acidifying agent, In this case as well, because of the simultaneous withdrawal of sulphur-containing offgases, the total sulphur balance in the system is kept constant.

In the context of a further embodiment, the process is carried out in a manner such that the demethylation of lignin is carried out continuously in the heat treatment reactor at temperatures of over 180° C., preferably over 200° C., in particular at or over 220° C., and therefore as complete a demethylation as possible of the lignin originally contained in the black liquor is carried out without at the same time having to be concerned about a condensation of lignin to form higher molecular weight products. During a heat treatment in a closed reactor, lignin is known to be in equilibrium with the gaseous products formed therefrom, which on the one hand leads to an autogenous pressure in the closed vessel and on the other hand, in particular when the system is opened and the products are suddenly depressurized, leads to a condensation of lignin. Surprisingly, it has been shown that despite the high temperatures in the heat treatment during a procedure, as described in the present case, the condensation of lignin can be avoided and a low molecular weight demethylated lignin can be prepared. This is because the volatile reaction products are withdrawn from the heat treatment and in fact, as described, are withdrawn either continuously or a plurality of times during a heat treatment, so that in the heat treatment vessel, neither an excessively increased pressure can form, nor can a condensation of lignin occur. Surprisingly, even at temperatures of over 200° C., a procedure of this type not only provides a sufficient demethylation of lignin, but surprisingly, unwanted structural changes of the lignin are prevented and do not occur, or only occur to a small extent, and in particular, the degree of polymerization of the phenolic macromolecules can be reduced and the proportion of phenolic hydroxyl groups can be increased, so that in total, the phenolic structure of the lignin can be retained.

In a further embodiment of the invention, because the demethylation is carried out in the heat treatment vessel with a continuous rise in the temperature, it is even easier to prevent a condensation of the lignin in the heat treatment vessel and in particular to prepare a demethylated low molecular weight lignin.

In a further embodiment of the invention, particularly advantageous results can be obtained in this regard when the heat treatment is carried out for a time period of at least 30 minutes, preferably 1 to 5 hours, particularly preferably approximately 90 minutes. In the case of a reaction period of this type, it can be ensured that on the one hand, a sufficient demethylation of the lignin contained in the black liquor is obtained, and on the other hand, the reaction period in each case is selected so as to be short enough for a condensation of the lignin to be preventable. Particularly in respect of the condensation of lignin, the duration of the heat treatment is preferably selected so as to be as brief as possible. If in the case of a procedure of this type, the procedure is such that DMS formed during the heat treatment as well as any other volatile reaction products which are formed is continuously withdrawn, then a rise in the pressure in the heat treatment vessel is avoided in each case, because the volatile sulphur-containing gases which are formed are continuously withdrawn and therefore, in particular, the reaction equilibrium can be displaced towards the demethylated product so that lignin can be demethylated for as long as methyl groups which can be eliminated are present in the unrefined lignin contained in the black liquor. At the same time, unwanted structural changes to the lignin are prevented.

In a further embodiment of the process, because H₂S withdrawn from the first precipitation stage is oxidized and products formed during the oxidation, such as H₂SO₄ and SO₂ where applicable as well as CO₂ and H₂O, can be supplied to the second precipitation stage as an acidifying agent, the gases withdrawn in the heat treatment stage as well as in the precipitation stage can be returned to the lignin preparation step in a circuit and this can then ensure that the sulphur balance in the system can be maintained, i.e. an excessive addition of sulphur is avoided because only sulphur which was already contained in the black liquor is withdrawn, for example as DIMS, and is transformed by oxidation into H₂SO₄ or SO₂ and then re-introduced into the process. In this manner, the sulphur balance is successfully kept constant.

The h₂S formed in the first or in the second precipitation stage can be processed in the same manner and also can be supplied to an oxidation step and then consequently can be introduced into the process as an acidifying agent.

In addition to the above extensively described continuous procedure, it is clearly also possible, and within the scope of the invention, to carry out the process in a discontinuous manner wherein, instead of carrying out the process in separate vessels, the individual steps of the process can be carried out in only one or even two vessels which can carry out a plurality of reaction steps, whereupon the expenditure in terms of equipment can be substantially reduced.

### DESCRIPTION OF THE DRAWINGS

The invention will now be described in more detail with the aid of figures and exemplary embodiments, in which:

FIG. 1 shows a processing concept for the demethylation of lignin as well as a two-stage acidification with sulphur-containing gases in accordance with the invention,

FIG. 2 shows a further embodiment of a processing concept of this type in which, in addition, sulphur-containing gases which have been withdrawn are supplied to an oxidation step,

FIG. 3 is a graph which shows the reduction in the Ph value during a procedure in accordance with the invention with both a black liquor heat treated in accordance with the invention and also a black liquor treated in accordance with the prior art, and

FIG. 4 shows a processing concept for the discontinuous implementation of the demethylation of lignin, as well as a two-stage acidification with sulphur-containing gases in accordance with the invention.

### DETAILED DESCRIPTION OF THE INVENTION

### Exemplary Embodiments

### Example 1

### Heat Treatment and Lignin Separation from Black Liquor on the Laboratory, Pilot and Industrial Scales

1 kg of black liquor (black liquor I) was supplied to a heat treatment reactor and the black liquor I was heat treated for 90 min at 220° C. Every 30 min, dimethyl sulphide (DMS) which had formed was withdrawn from the reactor, wherein care was taken to ensure that the pressure in the vessel was kept to a maximum of 30 bar or below. The black liquor I introduced into the system had a pH value of 13 at the inlet and 10 g/kg of black liquor of DMS could be obtained from the black liquor I during the heat treatment. After the heat treatment, cooling could be carried out before the final removal of DMS. The black liquor I obtained after the heat treatment herein had a pH value of 11.3 and was transferred into a precipitation stage where precipitation could be carried out either in a separate vessel or, in fact, in the heat treatment reactor. In order to precipitate out lignin, in a first precipitation stage, CO₂ was added as the acidifying agent and the black liquor slurry formed, which had a pH value of 9.9 after the addition of CO₂, was transferred into a second precipitation stage in which a second precipitation was carried out with additional H₂SO₄. The slurry which was withdrawn from it had a pH value of 9.4 for lignin. Next, a test was carried out either to withdraw lignin after the first precipitation stage with CO₂ and to observe the yield, or to investigate the yield after carrying out a second precipitation stage. In this regard, it was shown that the lignin yield with a single CO₂ precipitation was 90 g/kg of black liquor I and the lignin yield after carrying out a second precipitation stage with H₂SO₄ was 104 g/kg of black liquor I.

The procedure of Example 1 was repeated wherein, instead of the intermittent withdrawal of dimethyl sulphide, dimethyl sulphide was continuously withdrawn from the head of the reactor and the dimethyl sulphide which had been withdrawn was supplied to an oxidation step in order to oxidize it to H₂SO₄ or SO₂, which reaction product was in turn supplied to the second precipitation stage as the acidifying agent. In the case of a continuous procedure, in total a slight increase in the precipitated lignin could be observed at the end of the second separation stage; it was 107 g/kg of black liquor I.

### Example 2

The procedure of Example 1 was substantially followed, wherein black liquor from another pulp production, termed black liquor II, was used. The temperature in the heat treatment reactor was 200° C. The pressure in the heat treatment reactor was kept to 15 bar by intermittently withdrawing volatile components (without a withdrawal of the volatile components, a pressure of 18 bar would have been established). The yield of DMS in this case was 4.9 g/kg of black liquor II, which yield enabled an H₂SO₄ addition of at least 7.7 g/kg of black liquor II to be made in the precipitation stage 2.

### Example 3

The procedure of Example 1 was substantially followed, wherein black liquor from the digester of Example 2 was employed, however the black liquor originated from a digestion of a type of wood which differed from that of Example 2, hereinafter termed black liquor III. The temperature in the heat treatment reactor was 220° C. The pressure in the heat treatment reactor was adjusted to 24 bar by intermittently withdrawing the volatile components (without a withdrawal of the volatile components, a pressure of 40 bar would have been established), The yield of DMS in this case was 10.8 g/kg of black liquor III, which yield enabled an H₂SO₄ addition of at least 17 g/kg of black liquor III to be made in the precipitation stage 2, wherein the proportion of H₂S was not included in the calculations.

Finally in this context, it should also be noted that when H₂SO₄ is added in the second stage as the acidifying agent, the addition of the strong acid leads to the release of CO₂ together with H₂S by displacement of the carbonate equilibrium, whereupon the corresponding offgases, namely CO₂ and H₂S, can be recycled and, for example, can be supplied to the oxidation step in order to be oxidized to SO₂ or H₂SO₄. Here, all of the offgases may also be recycled to the first stage, for example, without any separation or purification, so that the CO₂ contained in the offgas is bound in a liquor which has a high pH value and the pH value falls and the H₂S can be withdrawn from the first stage as offgas and then either oxidized to acids, or may also be burned off. Other possible gaseous ingredients in the offgas do not interfere with the reaction, and therefore all the offgas could be recycled.

Finally, a test was carried out to supply sulphur-containing acid prior to the CO₂ precipitation, i.e. the first precipitation stage, which reduces the quantity of CO₂ required as the precipitation agent and therefore reduces the carbonate formation during the precipitation. In the case of this procedure, it has been shown that this is favourable to recycling of the filtrates after the filtration of lignin, because carbonate of the prior art is known to be able to cause problems with liquor evaporation.

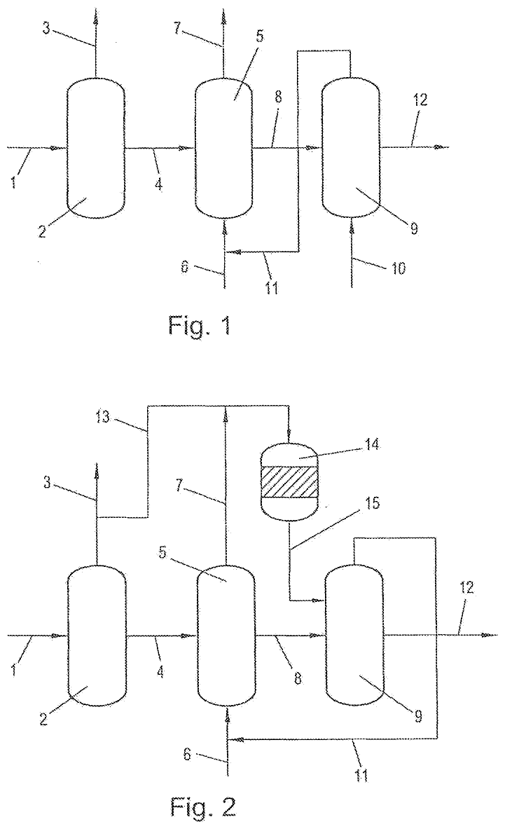

FIG. 1 shows a process schematic in which the DMS formed during the heat treatment is withdrawn intermittently. In this regard, at 1, black liquor with a pH value of 13 is introduced into a heat treatment reactor 2 in which the black liquor is heated to temperatures of up to 220° C. for a time period of between 0.5 and 4 hours. The DMS formed is withdrawn at 3 every time the pressure in the heat treatment reactor 2 exceeds the corresponding vapour pressure of water at the prevailing temperature, 220° C., however without vaporizing it. At the end of the reaction period, the treated black liquor, which now has a pH of 11.3, is transferred via line 4 into a first precipitation stage 5, in which an offgas or CO₂ as a pure gas is additionally introduced via line 6 in order to reduce the pH value and to facilitate the precipitation of lignin. The H₂S formed during this first precipitation is discharged at the head of the precipitation reactor via line 7 and the lignin-containing slurry, in particular demethylated lignin-containing slurry, which is formed, now with a pH value of 9.9, is introduced via line 8 into a second precipitation stage 9, in which a further precipitation is carried out with a strong mineral acid such as H₂SO₄ or SO₂ introduced via line 10. The offgases formed during this precipitation, namely H₂S and CO₂, can be recycled via line 11 to the first precipitation stage as an acidifying gas. The slurry formed in the second precipitation stage 9, which now has a pH of 9.4, is supplied via 12 to a lignin separation step. In this procedure, it has been shown that the yield of demethylated lignin can be increased by at least 30% compared with the process of the prior art and that although the sulphur balance in the system could be kept constant, the reaction equilibrium is displaced towards demethylated lignin so that a low-molecular-weight, non-condensed product is obtained which could be used directly in a further step of the process.

FIG. 2 shows an alternative procedure in which the reference numerals of FIG. 1 are retained as far as possible and which substantially corresponds to that of FIG. 1, however the DMS which is formed is withdrawn continuously and introduced into an oxidation process 14 via line 13, in which it is converted into H₂SO₄ or SO₂ as well as CO₂ and H₂O, This strong mineral acid which is formed is introduced into the second precipitation stage 9 via line 15 and therefore the external addition of sulphuric acid to the second precipitation stage is unnecessary. In the procedure in accordance with FIG. 2, the pH values in the system, in particular in the individual steps of the process, are the same as in FIG. 1, and also the yields are no different in principle. In general, a procedure of this type, however, ensures that the gases formed can be recycled so that the sulphur balance in the system is constant and in particular, an excessive input of mineral acid into the system can be avoided.

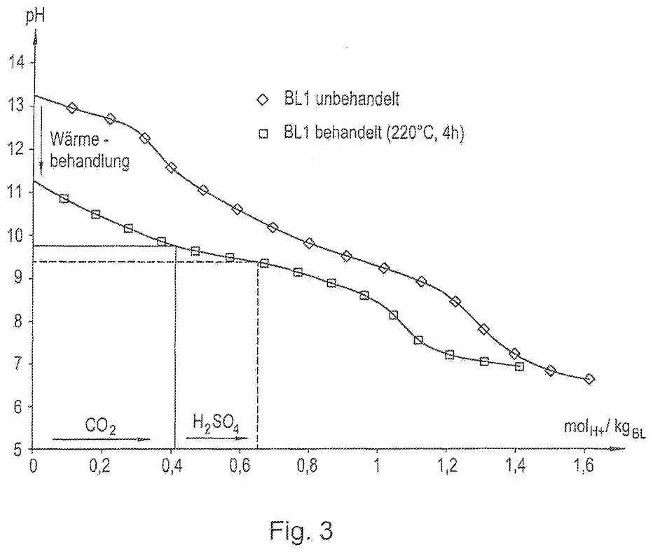

The graph of FIG. 3 shows that with the heat treatment in accordance with the present invention, the pH value of the black liquor employed can be significantly reduced in the heat treatment step, and also, in the precipitation stages, the pH value can alone be further reduced by the addition of the CO₂ and H₂SO₄ present in the system and the total requirement for H⁺ ions per kg of black liquor can be significantly reduced compared with the non-heat treated black liquor.

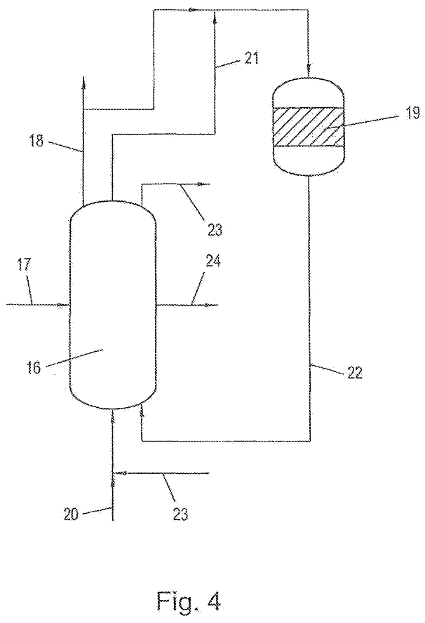

FIG. 4 shows a further embodiment of the process for the demethylation of lignin in accordance with the invention, in which the process is carried out in a batch mode reactor 16. In a first step, the heat treatment is carried out in the batch mode reactor 16, wherein unrefined black liquor with a pH of approximately 13 is introduced into the reactor 16 via line 17. Inside the heat treatment reactor 16, the black liquor is heated to 215° C. to 225° C. for a period of approximately 100 min and the dimethyl sulphide (DMS) formed during this heating is repeatedly withdrawn via line 18. If applicable, the DMS, as it is generally known, can undergo an oxidation reaction and be oxidized to form SO₂, as shown diagrammatically by the reactor 19. By withdrawing DMS from the black liquor which is present in the reactor 16, the total sulphur content of the black liquor remaining in the reactor 16 is reduced. The step for withdrawing DMS is carried out either continuously or in stages, in each case after exceeding a specific threshold pressure which, as a function of a temperature of approximately 200 to 225° C., in particular 215 to 225° C., is between approximately 15 and approximately 28 bar, in particular 20 to 28 bar. After this heat treatment step, in the second reaction step, CO₂ and offgases are supplied to the reactor 16 via the line 20, whereupon a first precipitation step takes place in the reactor 16. Hydrogen sulphide released during this precipitation step is withdrawn via line 21 and can either also be supplied to an oxidation step in the vessel 19, or can be processed otherwise. The withdrawal of H₂S reduces the sulphur content of the black liquor remaining in the reactor and at the same time increases the yield of SO₂ and H₂SO₄ after oxidation in the vessel 19. In a third step, the SO₂ or H₂SO₄ generated by the oxidation is now recycled via line 22 to the reactor 16 wherein, if insufficient SO₂ or H₂SO₄ is available, this may also be provided from an external source. Upon reaction of the black liquor remaining in the reactor 16 with SO₂ or H₂SO₄, a second lignin precipitation occurs, the offgases which are formed, namely H₂SO₄ and CO₂, which derive from the displacement of the carbonate equilibrium, are withdrawn from the reactor 16 via line 23. The offgases may in this case either be stored, or else be added to the next reaction batch in reactor 16 during the second step for a first precipitation of lignin, described above. After the completion of the three reaction steps which have been described, the demethylated lignin suspension formed in the reactor 16, which now has a pH of approximately 9, is withdrawn from the reactor 16 via line 24. The reactor 16 is then available for a fresh pass. In this context, it should be noted that the sequence of the steps, namely 1. heat treatment, 2. first precipitation by adding CO₂ and second precipitation by adding SO₂, may also be reversed to some extent, namely 1. heat treatment, 2. precipitation with SO₂ or H₂SO₄ and second precipitation with CO₂, without changing anything as regards the lignin suspension obtained from the reaction.

1. A process for separating lignin and volatile reaction products from a black liquor derived from pulp production, in which lignin contained in the black liquor is demethylated in a heat treatment reactor and CH₃⁺ ions separated out of the lignin are reacted with reduced sulphur-containing components from cooking chemicals contained in the black liquor to form DMS and DMS is withdrawn from the heat treatment reactor, a rise in pressure in the heat treatment reactor is controlled and DMS as well as other volatile or gaseous reaction products are withdrawn therefrom, repeatedly where necessary, when a pressure of ≥15 bar to approximately ≤40 bar, is reached in the heat treatment reactor, the black liquor which is depleted in DMS as well as other volatile reaction products is transferred to a first precipitation stage and CO₂ and/or sulphur-containing reaction products are added in order to precipitate out a slurry containing demethylated lignin, the slurry containing demethylated lignin is transferred into a second precipitation stage with at least one sulphur-containing acidifying agent, the precipitated unrefined slurry containing demethylated lignin is discharged from the second precipitation stage and subjected to a demethylated lignin separation step, a portion of the withdrawn other volatile reaction products are recycled to the process.

2. The process as claimed in claim 1, wherein the volatile reaction products from the heat treatment are continuously withdrawn from the heat treatment step.

3. The process as claimed in claim 1, wherein offgases withdrawn from the heat treatment reactor as well as from the first precipitation stage are supplied to the second precipitation stage as an acidifying agent.

4. The process as claimed in claim 1, wherein offgas containing CO₂ and H₂S withdrawn from the second precipitation stage is supplied to the first precipitation stage as an acidifying agent.

5. The process as claimed in claim 1, wherein the demethylation of lignin is carried out in the heat treatment reactor at temperatures of over 180° C.

6. The process as claimed in claim 1, wherein the demethylation of lignin is carried out in the heat treatment reactor with a continuous rise in the temperature.

7. The process as claimed in claim 6, wherein the heat treatment is carried out for a time period of at least 50 minutes.

8. The process as claimed in claim 6, wherein DMS formed during the heat treatment as well as other volatile reaction products which are formed are withdrawn continuously.

9. The process as claimed in claim 1, wherein H₂S withdrawn from the first and second precipitation stages is supplied to a common oxidation stage.
